(19) United States
(12) Patent Application Publication
(10) Pub. No.: US 2012/0072378 A1
(43) Pub. Date: Mar. 22, 2012

(54) Method for Brand Development and Creating, Evaluating and Selecting a Brand Name

(76) Inventors: Devon Thomas Treadwell, Minneapolis, MN (US); John Stucker, Minneapolis, MN (US)

(21) Appl. No.: 12/968,259

(22) Filed: Dec. 14, 2010

Related U.S. Application Data
(60) Provisional application No. 61/286,160, filed on Dec. 14, 2009.

(51) Int. Cl. G06Q 90/00

(52) U.S. Cl. 705/500

(57) ABSTRACT

A method of generating and evaluating a brand name including the steps of gathering client data, transforming the client data into a positioning brief having brand specific data, transforming the position brief data to generate a NAMESCAPE having brand name specific data, evaluating the NAMESCAPE data, transforming the positioning brief data and evaluated NAMESCAPE data into a brand name.

### PRIORITY

This application claims the benefit of U.S. Provisional Application Ser. No. 61/286,160, filed on Dec. 14, 2009, which is hereby incorporated by reference in its entirety herein.

### FIELD

This invention relates to a method of developing a brand, with emphasis on creating, evaluating and selecting a brand name. In particular, the method eliminates much of the subjectivity and personal biases that can destroy superior names during development. The present method transforms abstract client data into a useful, concrete name and/or brand identity

### BACKGROUND

Many methods exist for developing a brand and choosing a brand name. However, these methods are usually highly subjective and produce inconsistent results: a brand whose positioning is vague, overly broad or not unique, and/or having a name that's generic, bland, too similar to other names, or completely meaningless and without consideration for trademark availability. Most conventional methods are subject to personal biases resulting in multiple costly revisions and an inefficient process. Many current methods use poorly considered positioning, undisciplined creative efforts and research methods which are designed to elicit a specific response, leading to erroneous conclusions and weak, descriptive or meaningless names.

A need exists for a method of developing a brand, with a particular focus on a process for evaluating and selecting a brand name which uses objective criteria to arrive at a useful and concrete brand name that has the power to convey the brand's positioning when the customer hears it for the first time.

### SUMMARY OF THE INVENTION

In one aspect, the present method produces brand positioning, names and brand identities that immediately differentiate clients from their competitors.

According to one aspect, the present method consistently delivers powerful brands with instant meaning.

In another aspect, the present method creates brand positioning, names and brand identities that help increase awareness through word-of-mouth and interest from the media and may reduce the advertising expenses necessary to launch a brand.

In yet another aspect, the present method generates brand positioning, names and brand identities that not only gain brand awareness quickly in the short term but also remain a valuable asset in the long term.

### BRIEF DESCRIPTION OF THE DRAWINGS

FIG. 1 depicts a flow chart describing the steps of the present method.

### DETAILED DESCRIPTION OF THE INVENTION

The present method creates brands and brand names that are engaging, immediately meaningful and clearly express the distinctive positioning of the brand. The names and brand identities generated from the present method are rooted in a positioning that sets the brand apart from its competition. The present method may start with a clear positioning and ends with a tested method of gaining approvals on a concrete name. The present method transforms abstract information about the client, the client's competitors and the competitive landscape into names/brand identities, providing a useful, concrete and tangible result that conveys the new brand's personality and benefits, sets the brand apart from the competition, and has instant meaning to potential customers.

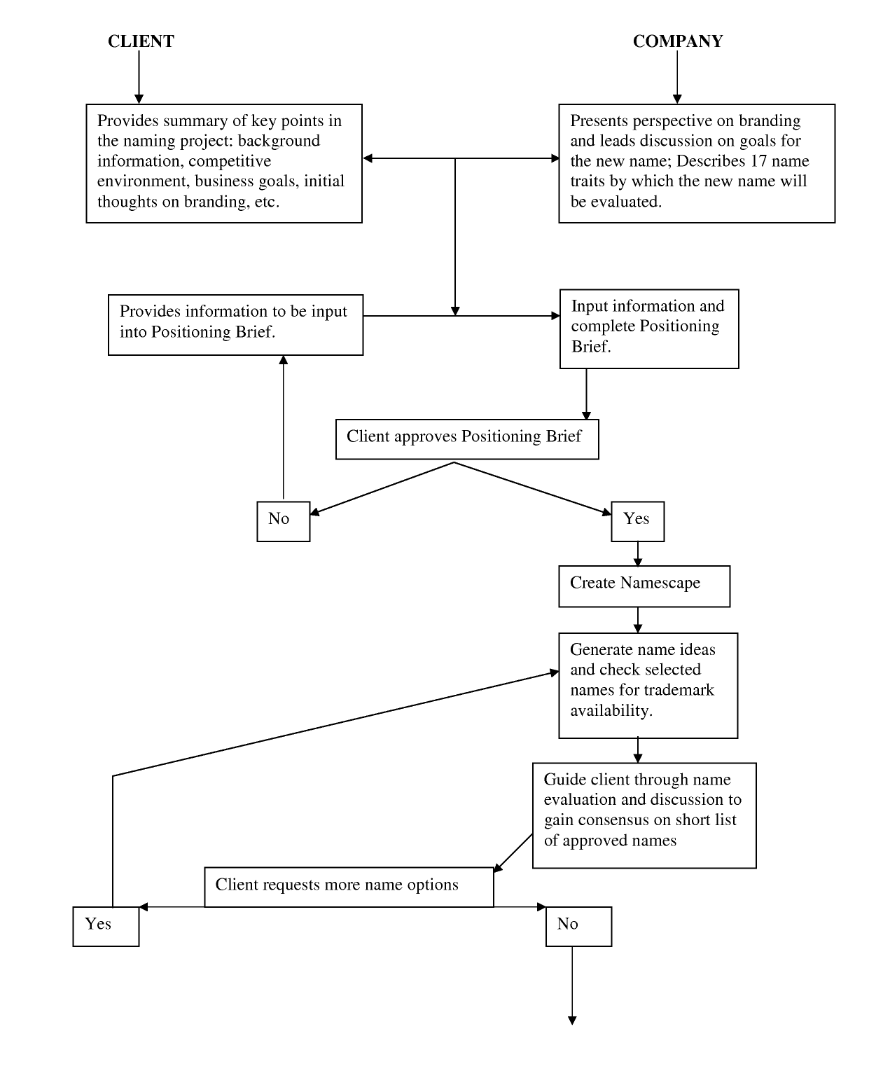

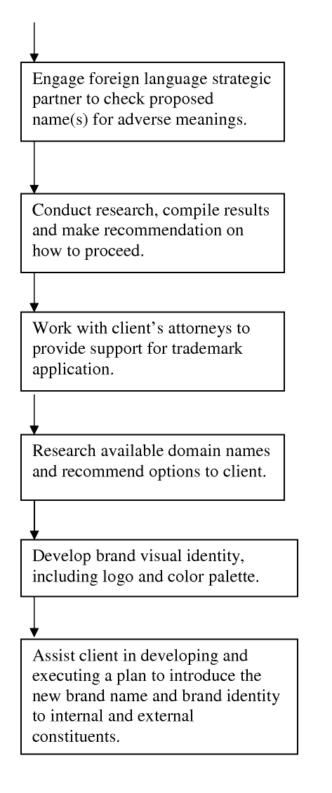

FIG. 1 illustrates a flow chart depicting an embodiment of a naming method according to the present method. The present method transforms a client's positioning brief into a concrete, useful name/brand identity for the client's product(s) and/or company. Step 1 may include establishing goals and groundwork. Step 1 may include substeps. Step 1a may include determining the goals the client wants the name to accomplish. Step 1b may include educating the client as to the characteristics that determine a powerful brand name. Such characteristics may include, but are not limited to: spelling, pronunciation, layers of meaning, positioning fit and gender appropriateness.

Step 2 may include the process of positioning. During step 2, information is gathered from the client to determine where the brand will be positioned. Such information may include, but is not limited to the client's passion, vision, purpose, audience, competitors and the brand promise and personality. This information may be transformed into a concrete positioning brief which may be read, reviewed and approved by the client.

Step 3 may include the process of creating and analyzing a NAMESCAPE. Step 3 may include several substeps. Step 3a may include collecting names of competitors via web research, public directories and other sources. Step 3b may include separating the names collected from step 3a into name type categories. Step 3c may include numerically ranking the categorized names by strength and effectiveness. Step 3d may include using the results from step 3c to determine which type of name the client's name brand should be. The NAMESCAPE is a concrete chart which may be read, reviewed and approved by the client.

Step 4 may include generating names. Step 4 may include substeps. Step 4a may include identifying concept categories from Step 2 and using creative thinking techniques to produce a collection of names that connect to the concept categories identified in Step 3. Step 4b may include checking the potential names for trademark review against the USPTO database. Only those names that pass an initial trademark review pass through to the next step.

Step 5 may include evaluating the selected names against the characteristics and criteria determined in Step 1. Step 5 may include substeps. Substep 5a may include rating each characteristic on a 1-10 scale to illuminate the strength and weakness of each name. Step 5b may include an internal audit of the scoring from step 5a. Step 5c may include repeating step 5a with the client's management team. Step 5d may include using the results from 5c to select a short list of names. Step 5e may include a trademark search of the names generated in step 5d.

Step 6 may include evaluating the names generated in step 5d against foreign languages to ensure there are no adverse or undesirable meanings inherent in the name.

Step 7 may include market research on the brand names which have survived through step 6 and may include substeps. Step 7a may include presenting the new brand name to a group of people from the target audience. Step 7b may include asking the target audience a series of questions designed to gauge how the audience would react to the name in a real world setting. Step 7c includes recording the outcome of step 7b and presenting the results along with a recommendation of brand name to the client.

Step 8 may include providing the names from Step 7c and other relevant background information to an intellectual property attorney to evaluate whether trademark applications should be filed. Depending on the results of the attorney's trademark search, some or all of the names may then continue to a trademark application.

Step 9 may include domain name selection and may include substeps. Step 9a may include researching available domain names using online tools and the WHOIS database. Step 9b may include providing the client with domain name recommendations based on Step 9a and appropriateness for the brand name. Step 9c may include providing the client with the owner of a particular domain name if the domain name is not available so that the client may offer a buyout of the desired domain name.

Step 10 may include an internal acceptance plan which introduces the new brand name to the client's internal constituents to ensure acceptance and understanding of the brand. Step 10 may further include creating various types of communications, which may include, but is not limited to: presentations, promotions and talking points.

Step 11 may include developing visual identity concepts based on the approved name.

Step 12 may include developing brand launch materials such as a visual identity system, brand identity guide, Web site design and printed sales collateral.

Steps 1 through 12 may be completed in the order recited herein, or the sequence may vary according to particular client needs or circumstances. In some embodiments, steps may be skipped altogether. Additional steps, information or criteria may also be factored into the process.

1. A method of generating and evaluating a brand name comprising:
gathering client data;
transforming the client data into a positioning brief having brand specific data;
transforming the positioning brief data to generate a NAMESCAPE having brand name specific data;
evaluating the NAMESCAPE data;
transforming the positioning brief data and evaluated NAMESCAPE data into a brand name.

2. The method of claim 1 further including the step of evaluating the brand name against the positioning brief data.

3. The method of claim 1 further including the step of checking the brand name for trademark availability.

4. The method of claim 1 further including the step of analyzing the brand name for foreign meaning.

5. The method of claim 1 further including the step of creating a visual identity generated from the brand name.
